(19) United States
(12) Patent Application Publication
(10) Pub. No.: US 2023/0088604 A1
(43) Pub. Date: Mar. 23, 2023

(54) BUSBAR AND THERMAL CUT-OFF DEVICE SUB-ASSEMBLY

(71) Applicant: Apple Inc., Cupertino, CA (US)

(72) Inventors: Brian J. Haskins, Campbell, CA (US); Jamie N. Forslin, Cupertino, CA (US); Liang Guo, San Jose, CA (US); Jian Wang, Suzhou (CN)

(21) Appl. No.: 17/878,321

(22) Filed: Aug. 1, 2022

Related U.S. Application Data
(60) Provisional application No. 63/247,482, filed on Sep. 23, 2021.

(51) Int. Cl. H01M 50/581; H01M 50/218; H01M 50/507

(52) U.S. Cl. CPC H01M 50/581; H01M 50/218; H01M 50/507

(57) ABSTRACT

The disclosed technology relates to a busbar and thermal cut-off device (TCO) sub-assembly. The sub-assembly may be configured to be connected to a first battery cell and a second battery cell. The sub-assembly may comprise a first busbar configured to electrically connect the first battery cell to the second battery cell when the sub-assembly is connected to the first battery cell and the second battery cell. The sub-assembly may comprise a first TCO connected directly to the first busbar. The sub-assembly may not extend above a top surface of the first battery cell when the sub-assembly is connected to the first battery cell.

### PRIORITY

The disclosure claims the benefit under 35 U.S.C. § 119(e) of U.S. Provisional Patent Application No. 63/247,482 entitled “Busbar and Thermal Cut-Off Device Sub-Assembly”, filed on Sep. 23, 2021, which is incorporated herein by reference in its entirety.

### TECHNICAL FIELD

The present disclosure relates generally to battery packs, and more particularly, to a busbar and thermal cut-off device (TCO) sub-assembly for use in a battery pack.

### BACKGROUND

Battery packs are used to provide power to a wide variety of portable electronic devices, including laptop computers, tablet computers, mobile phones, personal digital assistants (PDAs), digital music players, watches, and wearable devices.

Battery packs commonly include a plurality of cells. The plurality of cells may be configured in a series, parallel or a mixture of both to deliver a desired voltage, capacity, or power density. A busbar may be utilized to connect such cells together.

Battery packs also commonly include a TCO configured to interrupt electric current when heated to a specified temperature. The TCO may be connected to one of the cells before the cells are connected via the busbar. However, connecting the TCO to one of the cells before assembling the battery pack may be inefficient and may also waste valuable space within the battery pack.

### SUMMARY

The disclosed embodiments provide for busbar and thermal cut-off device (TCO) sub-assembly for use in a battery pack. The sub-assembly is configured to be connected to a first battery cell. The sub-assembly includes a busbar configured to electrically connect the first battery cell to a second battery cell when the sub-assembly is connected to the first battery cell. The sub-assembly includes a first TCO connected directly to the busbar. The sub-assembly does not extend above a top surface of the first battery cell when the sub-assembly is connected to the first battery cell.

In some embodiments, a battery pack is disclosed. The battery pack includes a first battery cell. The battery pack includes a sub-assembly configured to be connected to the first battery cell. The sub-assembly includes a busbar configured to electrically connect the first battery cell to a second battery cell when the sub-assembly is connected to the first battery cell. The sub-assembly includes a first TCO connected directly to the busbar. The sub-assembly does not extend above a top surface of the first battery cell when the sub-assembly is connected to the first battery cell.

In some embodiments, a method is disclosed. The method includes obtaining a first battery cell and a sub-assembly. The sub-assembly includes a busbar and a first TCO connected directly to the busbar. The method includes connecting the first battery cell to the sub-assembly to electrically connect the first battery cell to a second battery cell. The sub-assembly does not extend above a top surface of the first battery cell when the sub-assembly is connected to first battery cell.

### BRIEF DESCRIPTION OF THE DRAWINGS

The embodiments herein may be better understood by referring to the following description in conjunction with the accompanying drawings in which like reference numerals indicate identical or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is an exploded view of a thermal cut-off device (TCO) and cell sub-assembly.

FIG. 1B is an isometric view of a busbar configured to be connected to the sub-assembly of FIG. 1A.

FIG. 2 is an isometric view of a sub-assembly including a TCO and a busbar connected via a tab.

FIG. 3 is side view of the sub-assembly of FIG. 2.

FIG. 4A is an example method for manufacturing the sub-assembly of FIG. 1A.

FIG. 4B is an example method for manufacturing a battery pack using the sub-assembly of FIG. 1A.

FIG. 5 is an isometric view of a sub-assembly including a TCO directly connected to a busbar.

FIG. 6A is a side view of the sub-assembly of FIG. 5.

FIG. 6B is isometric view of the sub-assembly of FIG. 5 connected to a cell.

FIG. 7 is an isometric view of a sub-assembly including a plurality of TCOs directly connected to a busbar.

FIG. 8 is an exploded view of the sub-assembly of FIG. 7.

FIG. 9 is an example method for manufacturing a battery pack including the sub-assembly of FIG. 5.

FIG. 10 is a portable electronic device.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Battery packs are used to provide power to a wide variety of portable electronic devices, including laptop computers, tablet computers, mobile phones, personal digital assistants (PDAs), digital music players, watches, and wearable devices.

Battery packs commonly include a plurality of cells. The plurality of cells may be configured in a series, parallel or a mixture of both to deliver a desired voltage, capacity, or power density. A busbar may be utilized to connect such cells together.

Battery packs also commonly include a TCO configured to interrupt electric current when heated to a specified temperature. The TCO may be connected to one of the plurality of cells before the plurality of cells are connected via the busbar. However, connecting the TCO to one of the plurality of cells before assembling the battery pack may be inefficient and may also waste valuable space within the battery pack.

Connecting the TCO to one of the plurality of cells before assembling the battery pack may add additional step(s) in the manufacturing process. Such additional step(s) may be inefficient and/or costly. Such additional step(s) may also be bad for the environment, as the additional step(s) may involve the transportation of battery pack components. Such transportation may contribute to carbon emissions.

Connecting the TCO to one of the plurality of cells before assembling the battery pack may waste valuable space within the battery pack. For example, the TCO may be connected to the cell using bulky adhesive and/or tape. Such adhesive or tape may waste space within the battery pack. Additionally, connecting the TCO/cell assembly to the busbar may require the use of a tab (e.g., interposer tab). Such a tab may occupy valuable space within the battery pack. As a result, the battery pack may be bulky or it may be difficult to fit the other components within the battery pack.

Accordingly, techniques for assembling a battery pack without first connecting the TCO to one of the cell are needed. The disclosed technology addresses the foregoing limitations of conventional battery packs and conventional battery back assembly processes by introducing a sub-assembly including a TCO directly connected to a busbar. Such a TCO/busbar sub-assembly eliminates the need to connect the TCO to one of the cells before assembling the battery pack.

By eliminating the need to connect the TCO to one of the cells before assembling the battery pack, additional step(s) in the manufacturing process may be eliminated. Eliminating such additional step(s) may reduce the overhead in the battery pack assembly process.

The TCO/busbar sub-assembly disclosed herein also occupies less space within the battery pack than the previously used TCO/cell sub-assembly. Use of the TCO/busbar sub-assembly may increase the efficiency of the battery pack to deliver power to the portable electronic device. The TCO/busbar sub-assembly may allow for larger busbars to be used and larger, lower impedance TCOs to be used. Overall, TCO/busbar sub-assembly leads to higher efficiency and lower cost.

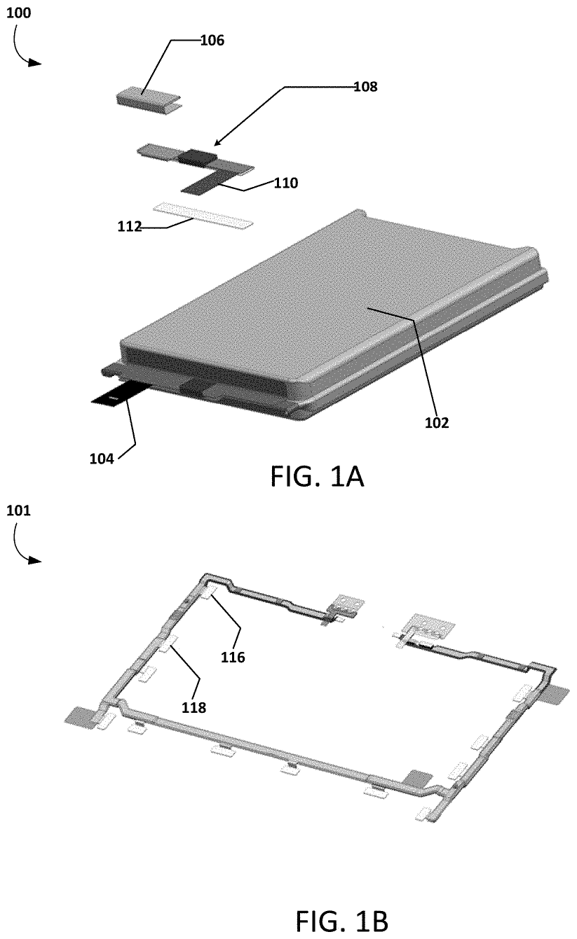

FIG. 1A is an exploded view of a TCO and cell sub-assembly 100. The TCO and cell sub-assembly 100 includes a cell 102 and a TCO 108.

The cell 102 may comprise an enclosure configured to enclose a battery stack. The cell 102 may comprise a negative tab 104. The battery stack may include a plurality of layers. The set of layers may comprise a cathode with an active coating, a separator, and an anode with an active coating. For example, the cathode may be an aluminum foil coated with a lithium compound (e.g., LiCoO2, LiNCoMn, LiCoAl or LiMn2O4) and the anode may be a copper foil coated with carbon or graphite. The separator may include polyethylene (PE), polypropylene (PP), and/or a combination of PE and PP, such as PE/PP or PP/PE/PP.

The plurality of layers may be wound to form a jelly roll structure or can be stacked to form a stacked-cell structure. The plurality of layers may be immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The TCO 108 may be connected to the cell 102 via an adhesive 112 and/or a piece of tape 106. The TCO 108 may be configured to interrupt electric current when heated to a specified temperature. For example, the TCO 108 may be configured to interrupt electric current when the battery stack reaches a specified temperature. The TCO 108 may comprise a positive tab 112.

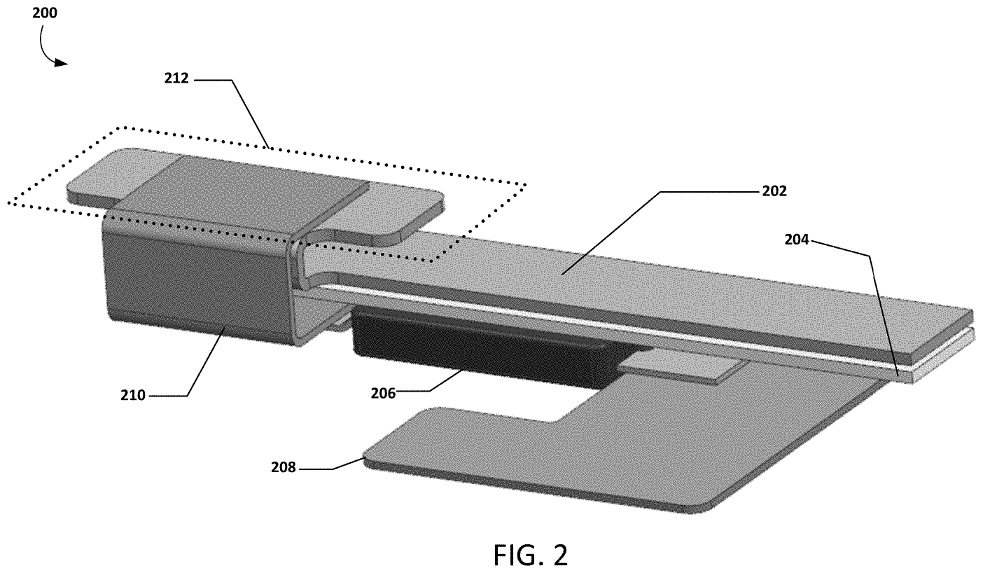

FIG. 1B is an isometric view of a busbar 101 configured to be connected to the TCO and cell sub-assembly 100. The busbar 101 may be connected to the TCO and cell sub-assembly 100 via an interposer tab. Such an interposer tab is discussed below in more detail with regard to FIG. 2. The busbar 101 may comprise a positive tab 116 and a negative tab 118. The positive tab 116 may be connected (e.g., welded) to the positive tab 112. The negative tab 118 may be connected (e.g., welded) to the negative tab 104.

FIG. 2 is an isometric view of a sub-assembly 200 including a TCO 206 and a first busbar 202 connected via an interposer tab 210. The TCO 206 may be directly connected to a positive tab 208. The positive tab 208 may be configured to be connected to a positive tab of a battery cell. The sub-assembly 200 may include a second busbar 204 interposed between the first busbar 202 and the TCO 206.

The TCO 206 may be connected (e.g., welded) to the interposer tab 210. The interposer tab 210 may be a material comprising nickel. The interposer tab 210 may be connected (e.g., welded) to the busbar 202 in a region 212. The region 212 may be, for example, a weld area. In this manner, the interposer tab 210 may connect the TCO 206 and the busbar 202.

As discussed above, connecting the TCO to one of the plurality of cells before assembling the battery pack may waste valuable space within the battery pack. For example, the TCO may be connected to one of the plurality of cells using an interposer tab (e.g., interposer tab 210). Such an interposer tab may occupy valuable space within the battery pack. As a result, the battery pack may be bulky or it may be difficult to fit the other components within the battery pack.

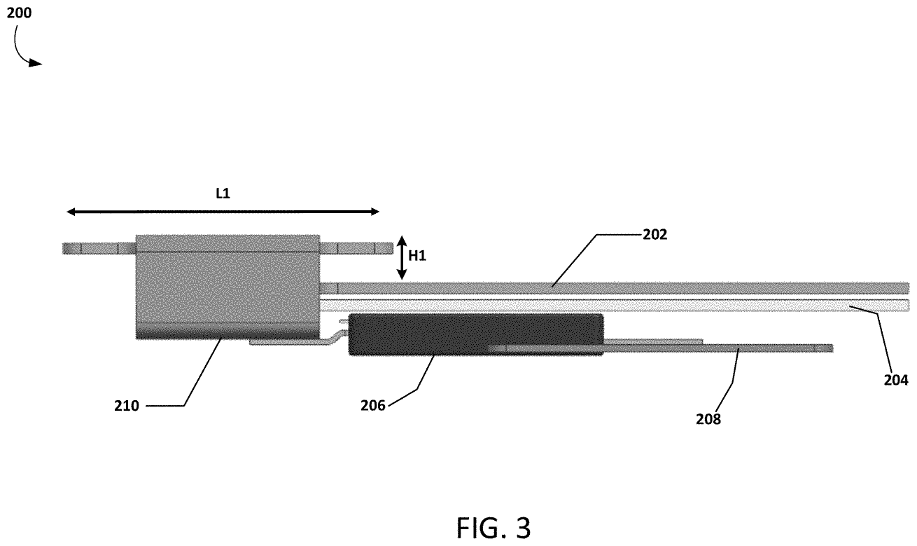

FIG. 3 is side view of the sub-assembly 200 of FIG. 2. The region 212 may be associated with a length L1. The length L1 may be, for example, 9 mm, 10 mm, or any other distance. Accordingly, when the sub-assembly 200 is used to assemble a battery pack, the length L1 of the interposer tab 212 causes the interposer tab 212 to occupy valuable space within the battery pack.

The interposer tab 212 may also add a height H1 to the height of the sub-assembly 200. Accordingly, when the sub-assembly 200 is used to assemble a battery pack, the height H1 associated with the interposer tab 212 causes the interposer tab 212 to occupy valuable space within the battery pack.

As also discussed above, connecting the TCO to a cell before assembling the battery pack adds additional steps in the manufacturing process. Such additional steps may be inefficient and/or costly. Such additional steps may also have detrimental effects on the environment, as the additional steps may involve the transportation of battery pack components. Such transportation may contribute to carbon emissions.

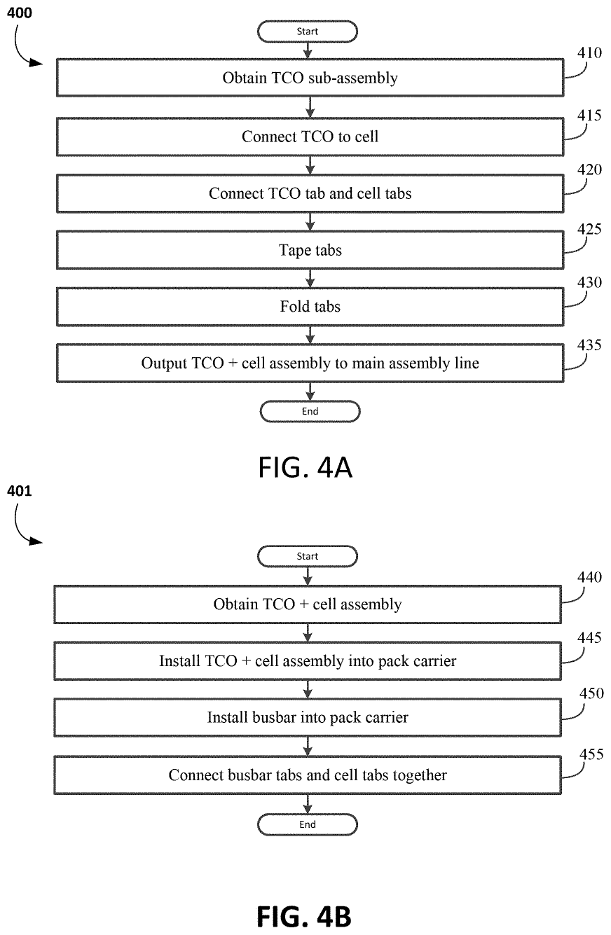

Such additional steps are illustrated in the method 400 depicted in FIG. 4A. FIG. 4A is an example method 400 for manufacturing the TCO and cell sub-assembly 200. At operation 410, a TCO sub-assembly (e.g., TCO sub-assembly 108) may be obtained. At operation 415, the TCO sub-assembly may be connected to a cell (e.g., cell 102). At operation 420, the TCO tabs and cell tabs may be connected. For example, a negative tab may be connected to the cell and a positive tab may be connected to the TCO sub-assembly. At operation 425, the tabs may be taped. At operation 430, the tabs may be folded. At operation 435, the resulting TCO and cell sub-assembly may be output, such as to a main assembly line for the assembly of a battery pack.

FIG. 4B is an example method 401 for manufacturing a battery pack using the TCO and cell sub-assembly 200 manufactured according to the method of FIG. 4A. At operation 440, the TCO and cell sub-assembly 200 may be obtained. At operation 445, the TCO and cell sub-assembly 200 may be installed into a battery pack carrier. At operation 450, a busbar (e.g., busbar 101) may be installed into the battery pack carrier. At operation 455, the busbar tabs and the cell tabs may be connected (e.g., welded) together.

The disclosed technology addresses the foregoing limitations of conventional battery packs and conventional battery back assembly processes by introducing a sub-assembly including a TCO directly connected to a busbar.

By eliminating the need to connect the TCO to the cell before assembling the battery pack, the method 400 may be eliminated from the manufacturing process. Eliminating the method 400 from the manufacturing process may save time, money, and/or energy.

Additionally, directly connecting the TCO to the busbar eliminates the need for the interposer tab and eliminates the need for adhesive/tape to connect the TCO to the cell. Eliminating the interposer tab and the adhesive/tape means that less valuable space within the battery pack will be occupied. For example, the length L1 and height H1 of the interposer tab may no longer occupy valuable space within the battery pack. Eliminating the interposer tab may also reduce the overall resistance of the battery pack.

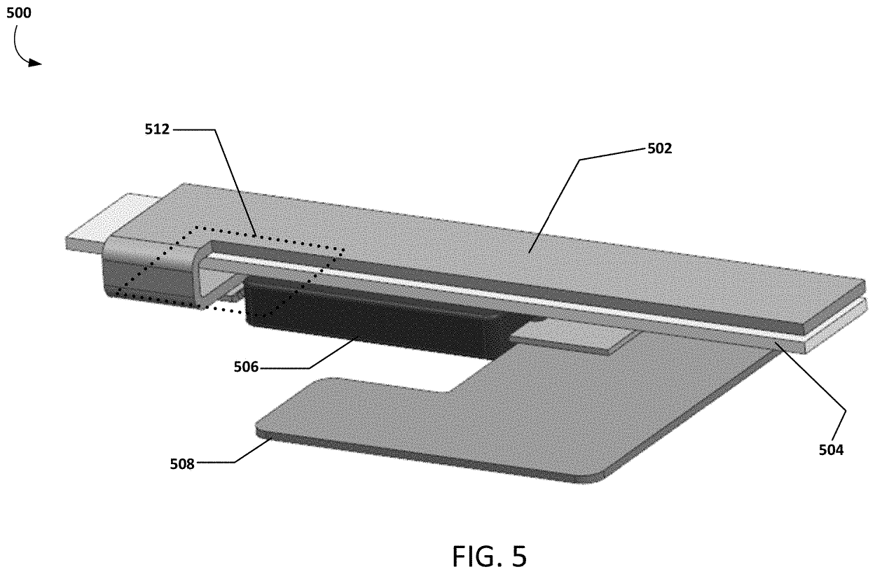

FIG. 5 is an isometric view of a sub-assembly 500 including a TCO 506 directly connected (e.g., welded) to a busbar 502, in accordance with various aspects of the subject technology. The busbar 502 may be a material comprising copper. The busbar 502 may comprise a negative tab. The negative tab may be configured to be connected to a negative tab of a battery cell.

The TCO 506 may be directly connected (e.g., welded) to the busbar 502 in a region 512. The region 512 may be, for example, a weld area. The TCO 506 may be the same material as the busbar 502. For example, the TCO 506 may be a material comprising copper.

The TCO 506 may be directly connected (e.g., welded) to a positive tab 508. The positive tab 508 may be configured to be connected to a positive tab of a battery cell. The sub-assembly 500 may include a second busbar 504 interposed between the first busbar 502 and the TCO 506.

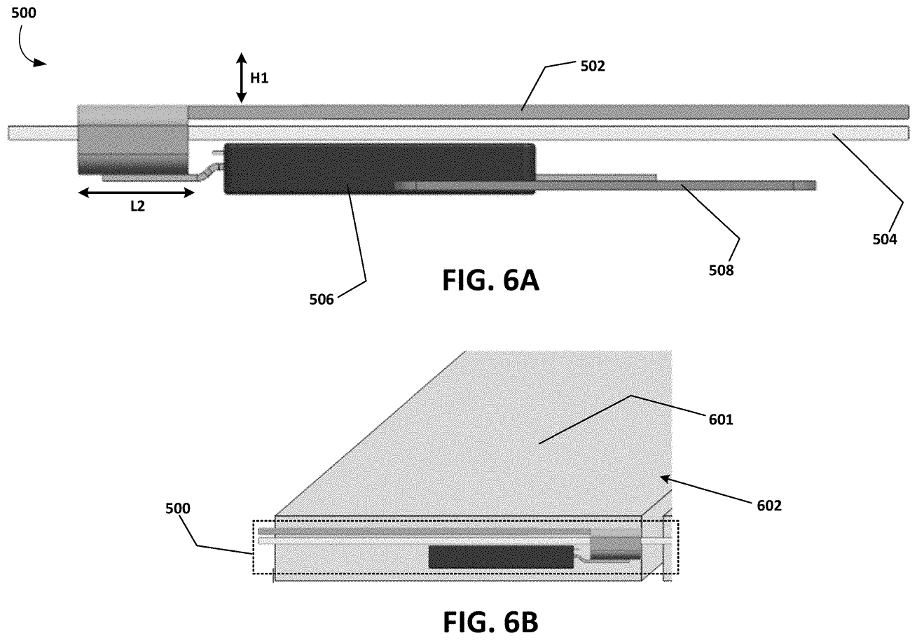

As discussed above, directly connecting the TCO directly to the busbar may save valuable space within the battery pack. FIG. 6A is side view of the sub-assembly 500 of FIG. 5. The region 512 may be associated with a length L2. The length L2 may be less than the length L1 of the interposer tab. For example, the length L2 may be 3 mm, 4 mm, or any other distance that is less than the length of L1. The height H1 associated with the interposer tab is eliminated.

Thus, by eliminating the interposer tab, the amount of space saved in terms of width may be equal to at least the difference between L1 and L2 and the amount of space saved in terms of height may be equal to at least H1. The sub-assembly 500 eliminates the need for tape (e.g., tape 106) and/or adhesive (e.g., adhesive 112) to attach the TCO to the cell. By eliminating such tape or adhesive, additional space in the battery pack may be saved.

The saved space created by the sub-assembly 500 may allow larger busbars to be used in the battery pack and/or may allow for larger, lower impedance TCOs to be used in the battery pack. Removing the interposer tab may also reduce the overall resistance of the battery pack.

FIG. 6B is isometric view of the sub-assembly 500 of FIG. 5 connected to a cell 602.

The cell 602 may comprise an enclosure configured to enclose a battery stack. The battery stack may include a plurality of layers. The set of layers may comprise a cathode with an active coating, a separator, and an anode with an active coating. For example, the cathode may be an aluminum foil coated with a lithium compound (e.g., LiCoO2, LiNCoMn, LiCoAl or LiMn2O4) and the anode may be a copper foil coated with carbon or graphite. The separator may include polyethylene (PE), polypropylene (PP), and/or a combination of PE and PP, such as PE/PP or PP/PE/PP.

The plurality of layers may be wound to form a jelly roll structure or can be stacked to form a stacked-cell structure. The plurality of layers may be immersed in an electrolyte, which for example, can be a LiPF6-based electrolyte that can include Ethylene Carbonate (EC), Polypropylene Carbonate (PC), Ethyl Methyl Carbonate (EMC) or DiMethyl Carbonate (DMC). The electrolyte can also include additives such as Vinyl carbonate (VC) or Polyethylene Soltone (PS). The electrolyte can additionally be in the form of a solution or a gel.

The cell 602 may comprise a positive tab and a negative tab. The positive tab of the cell may be configured to be connected (e.g., welded) to the positive tab 508. The negative tab of the cell may be configured to be connected (e.g., welded) the negative tab of the busbar.

Because the height H1 associated with the interposer tab is eliminated, the sub-assembly 500 may not extend above a top surface 601 of the battery cell 602 when the sub-assembly 500 is connected to the battery cell 602. The battery cell 602 may be connected to the sub-assembly 500, for example, when the positive tab of the cell is connected to the positive tab 508 and the negative tab of the cell is connected to the negative tab of the busbar.

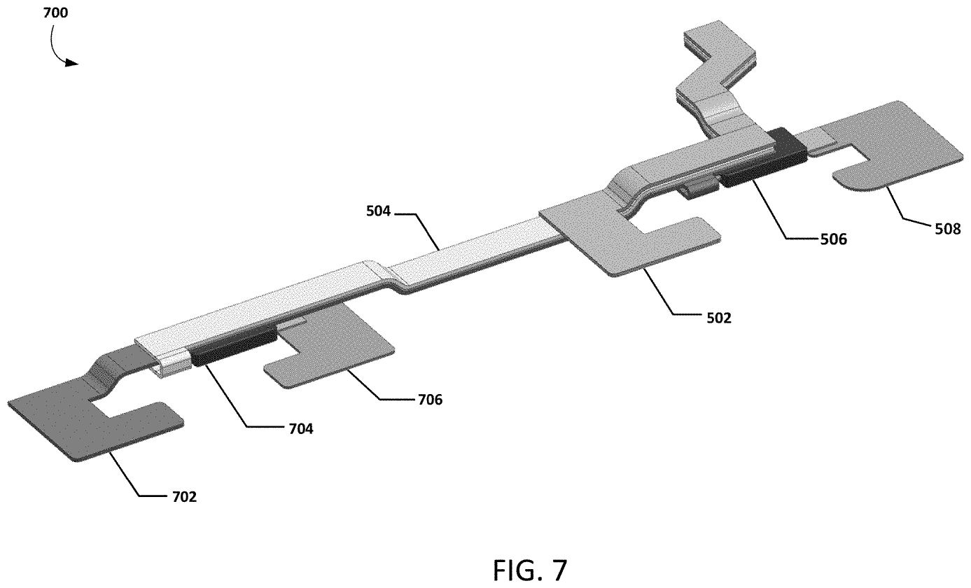

FIG. 7 is an isometric view of a sub-assembly 700 including a plurality of TCOs. As discussed above, the sub-assembly 500 includes a first TCO 506 directly connected to the busbar 502. The first TCO 506 may be directly connected to a positive tab 508. The positive tab 508 may be configured to be connected to a positive tab of a first battery cell. The sub-assembly 700 may not extend above a top surface of the first battery cell when the sub-assembly 700 is connected to the first battery cell.

The sub-assembly 500 may include a second busbar 504 interposed between the first busbar 502 and the first TCO 506. The second busbar 504 may comprise a negative tab. The negative tab of the busbar may be configured to be connected to a negative tab of a second battery cell.

The second busbar 504 may be directly connected to a second TCO 704. The second TCO 504 may be directly connected to a positive tab 706. The positive tab 706 may be configured to be connected to a positive tab of the second battery cell. The sub-assembly 700 may not extend above a top surface of the second battery cell when the sub-assembly 700 is connected to the second battery cell.

The second busbar 504 may be a material comprising copper. The second TCO 704 may be the same material as the busbar 504. For example, the second TCO 704 may be a material comprising copper.

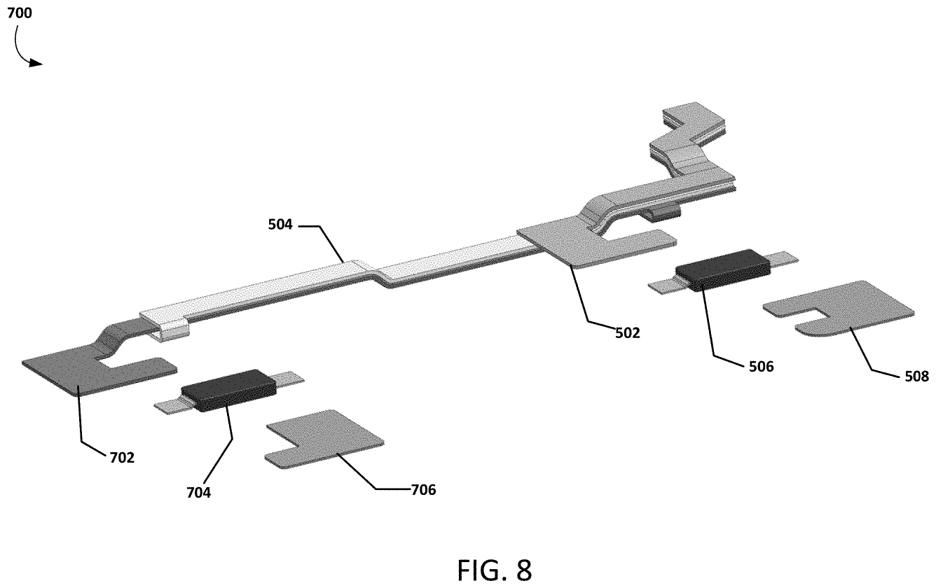

FIG. 8 is an exploded view of the sub-assembly of FIG. 7. The first TCO 506 may be laser welded to the busbar 502. The first TCO 506 may be laser welded to the positive tab 508. The second busbar 504 may be laser welded to the second TCO 704. The second TCO 504 may be laser welded to the positive tab 706.

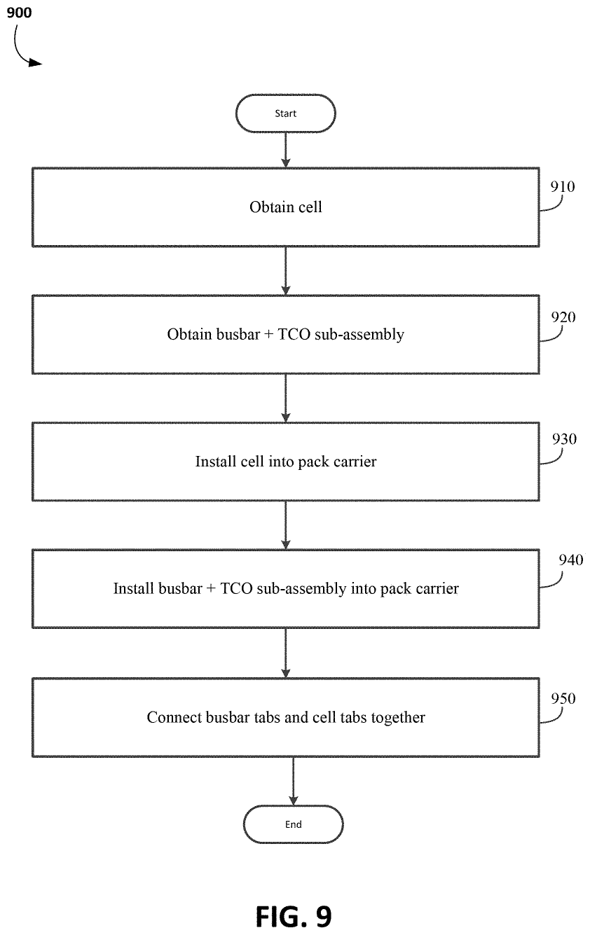

FIG. 9 illustrates an example method 900 for manufacturing a battery pack, in accordance with various aspects of the subject technology. It should be understood that, for any process discussed herein, there can be additional, fewer, or alternative steps performed in similar or alternative orders, or in parallel, within the scope of the various embodiments unless otherwise stated.

At operation 910, the cell 602 may be obtained. The cell 602 may be obtained, for example, from a first party. At operation 920, the sub-assembly 500 may be obtained. The sub-assembly 500 may be obtained, for example, from a second party that is different than the first party. As the sub-assembly 500 already comprises the busbar and TCO directly connected to one another, the TCO does not need to be connected to the cell 602 before the battery pack is assembled. For example, the method 400 described above may not need to be performed.

At operation 930, the cell may be installed into a pack carrier. At operation 940, the sub-assembly 500 may be installed into the pack carrier.

At operation 950, the sub-assembly 500 tab(s) and cell tab(s) may be connected together. For example, a positive tab of the battery cell may be connected (e.g., welded) to a positive tab of the sub-assembly 500. Likewise, a negative tab of the battery cell may be connected to a negative tab of the sub-assembly, such as a negative tab of the busbar.

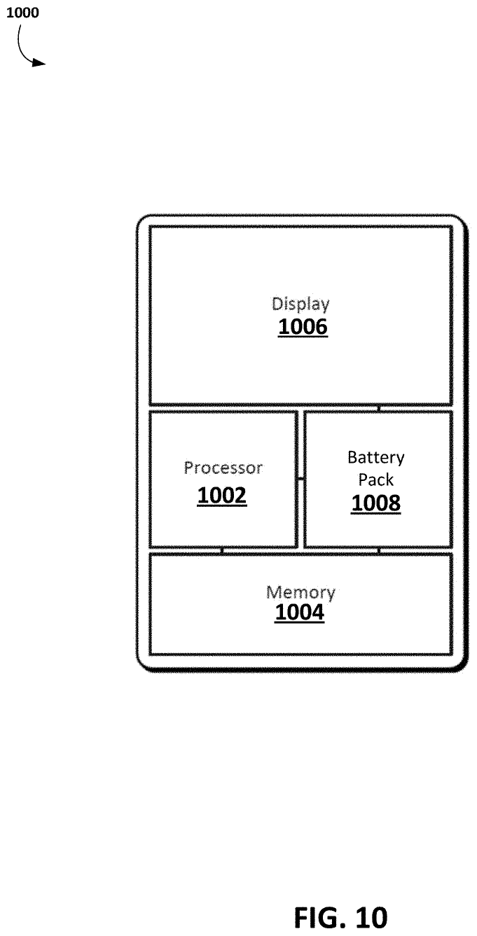

FIG. 10 is a portable electronic device 1000, in accordance with various aspects of the subject technology. The portable electronic device 1000 may include a battery pack 1008, a processor 1002, a memory 1004 and a display 1006, which are all powered by the battery pack 1008. Portable electronic device 1000 may correspond to a laptop computer, tablet computer, mobile phone, personal digital assistant (PDA), digital music player, watch, and wearable device, and/or other type of battery-powered electronic device.

Battery pack 1008 may include a first battery cell 602 and a sub-assembly 500 configured to be connected to the first battery cell 602. The sub-assembly may include a first busbar 502 configured to electrically connect the first battery cell 602 to a second battery cell when the sub-assembly 500 is connected to the first battery cell 602. The sub-assembly 500 may include a first TCO 506 connected directly to the first busbar 502. The sub-assembly 500 may not extend above a top surface 601 of the first battery cell 602 when the sub-assembly 500 is connected to the first battery cell 602.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A sub-assembly configured to be connected to a first battery cell, the sub-assembly comprising:
a first busbar configured to electrically connect the first battery cell to a second battery cell when the sub-assembly is connected to the first battery cell; and
a first thermal cut-off device (TCO) connected directly to the first busbar, wherein the sub-assembly does not extend above a top surface of the first battery cell when the sub-assembly is connected to the first battery cell.

2. The sub-assembly of claim 1, wherein the first battery cell comprises a first positive tab, and wherein the sub-assembly further comprises a second positive tab connected directly to the first TCO, wherein the first positive tab is configured to be connected to the second positive tab.

3. The sub-assembly of claim 1, wherein the sub-assembly is further configured to be connected to a third battery cell, the sub-assembly further comprising:
a second busbar configured to electrically connect the second battery cell to the third battery cell; and
a second TCO connected directly to the second busbar, wherein the sub-assembly does not extend above a top surface of the second battery cell when the sub-assembly is connected to the second battery cell.

4. The sub-assembly of claim 3, wherein the second battery cell comprises a first positive tab, and wherein the sub-assembly further comprises a second positive tab connected directly to the second TCO, wherein the first positive tab is configured to be connected to the second positive tab.

5. The sub-assembly of claim 1, wherein the first busbar is a material comprising copper and the first TCO is the same material.

6. A battery pack comprising:
a first battery cell; and
a sub-assembly configured to be connected to the first battery cell, the sub-assembly comprising:
a first busbar configured to electrically connect the first battery cell to a second battery cell when the sub-assembly is connected to the first battery cell; and
a first thermal cut-off device (TCO) connected directly to the first busbar, wherein the sub-assembly does not extend above a top surface of the first battery cell when the sub-assembly is connected to the first battery cell.

7. The battery pack of claim 6, wherein the first battery cell comprises a first positive tab, and wherein the sub-assembly further comprises a second positive tab connected directly to the first TCO, wherein the first positive tab is configured to be connected to the second positive tab.

8. The battery pack of claim 6, wherein the sub-assembly further comprises:
a second busbar configured to electrically connect the second battery cell to a third battery cell; and
a second TCO connected directly to the second busbar, wherein the sub-assembly does not extend above a top surface of the second battery cell when the sub-assembly is connected to the second battery cell.

9. The battery pack of claim 8, wherein the second battery cell comprises a first positive tab, and wherein the sub-assembly further comprises a second positive tab connected directly to the second TCO, wherein the first positive tab is configured to be connected to the second positive tab.

10. The sub-assembly of claim 1, wherein the first busbar is a material comprising copper and the first TCO is the same material.

11. A method comprising:
obtaining a first battery cell;
obtaining a sub-assembly, the sub-assembly comprising:
a first busbar; and
a first thermal cut-off device (TCO) connected directly to the first busbar; and
connecting the first battery cell to the sub-assembly to electrically connect the first battery cell to a second battery cell, wherein the sub-assembly does not extend above a top surface of the first battery cell when the sub-assembly is connected to first battery cell.

12. The method of claim 11, wherein the first battery cell is obtained from a first party.

13. The method of claim 12, wherein the busbar is manufactured by a second party and the sub-assembly is obtained from the second party.

14. The method of claim 11, wherein the first battery cell comprises a first positive tab, and wherein the sub-assembly further comprises a second positive tab connected directly to the first TCO.

15. The method of claim 11, wherein connecting the first battery cell to the sub-assembly to electrically connect the first battery cell to the second battery cell comprises connecting the first positive tab to the second positive tab.

16. The method of claim 11, wherein the sub-assembly further comprises:
a second busbar configured to electrically connect the second battery cell to a third battery cell; and
a second TCO connected directly to the second busbar.

17. The method of claim 16, further comprising:
connecting the second battery cell to the sub-assembly to electrically connect the second battery cell to the third battery cell, wherein the sub-assembly does not extend above a top surface of the second battery cell when the sub-assembly is connected to second battery cell.

18. The method of claim 16, wherein the second battery cell comprises a first positive tab, and wherein the sub-assembly further comprises a second positive tab connected directly to the second TCO.

19. The method of claim 18, further comprising connecting the first positive tab to the second positive tab.

20. The method of claim 11, wherein the first busbar is a material comprising copper and the first TCO is the same material.
